(19) United States
(12) Patent Application Publication
(10) Pub. No.: US 2001/0035295 A1
(43) Pub. Date: Nov. 1, 2001

(54) Device for spacing multiple wires and/or cables

(76) Inventor: Paul Cipollone, Maderia, OH (US)

Correspondence Address: Marianne Dressman, 3939 Von Rissen Court, Cleves, OH, 45002, US

(21) Appl. No.: 09/813,721

(22) Filed: Mar. 21, 2001

Related U.S. Application Data
(60) Provisional application No. 60/194,779, filed on Apr. 5, 2000.

(51) Int. Cl. H02G 3/00

(52) U.S. Cl. 174/72 A

(57) ABSTRACT

A device for spacing, positioning and holding multiple telephone and/or electric lines is disclosed. More particularly a device for spacing, positioning and holding multiple telephone and/or electric lines for use with computer equipment and accessories is disclosed.

### CROSS REFERENCE TO RELATED APPLICATION

This application claims priority to U.S. Provisional Application Ser. No. 60/194,779 filed Apr. 5, 2000.

### FIELD OF THE INVENTION

This invention relates to a device for spacing, positioning and holding multiple telephone and/or electric lines. More particularly for spacing, positioning and holding multiple telephone and/or electric lines for use with computer equipment and accessories.

### BACKGROUND OF THE INVENTION

Computers, computer accessories and electrical devices of all kinds have become pervasive in all aspects of modern life. As a result of the need for every device to be supplied with electrical power, in addition to being connected to a telephone, network or fax cable, there are several wires and cables tangled under many desks.

A tangle of wires and electrical lines not only presents an unsightly mess but is also a fire hazard.

Accordingly the need remains for a device, which efficiently and effectively organizes the wires and electrical lines associated with computers, telephones, faxes and any other electrical devices. There is also a need for a device, which is easy to produce, available at a low cost and attractive to the consumer.

### SUMMARY OF THE INVENTION

The present invention meets the aforementioned needs by providing a spacing device for maintaining numerous wires and/or electrical lines in an untangled manner.

In accordance with a first aspect of the invention a device is provided comprising a one-piece flat section with a longitudinal score line at the midline separating the upper and lower sections.

### BRIEF DESCRIPTION OF THE DRAWINGS

FIG. 1. is a top view of a device according to the present invention.

### DETAILED DESCRIPTION OF THE INVENTION

The present invention is directed to a device for spacing, positioning and organizing multiple telephone and/or electric lines. More particularly for spacing, positioning and holding multiple telephone and/or electric lines for use with computer equipment and accessories.

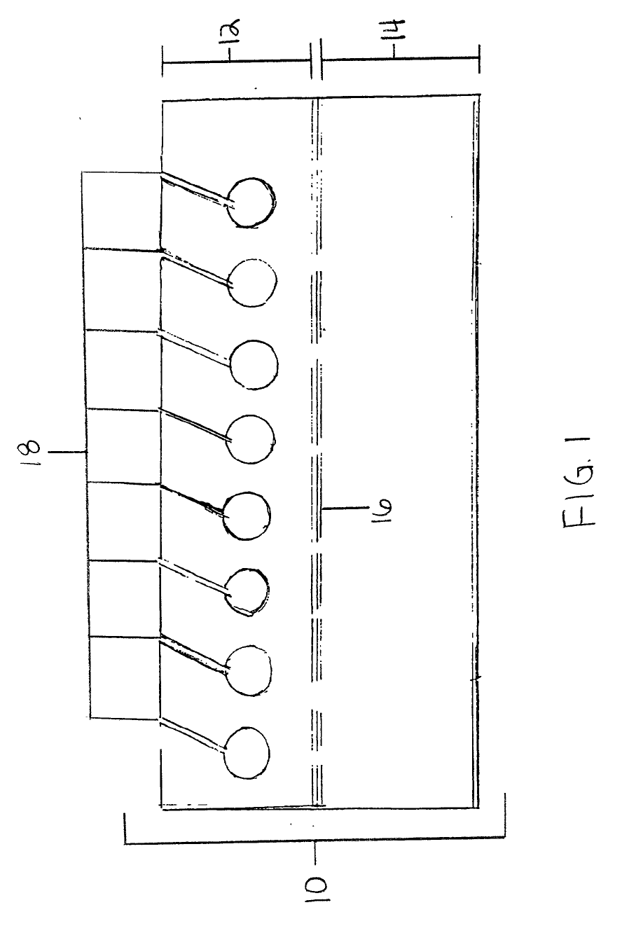

Turning now to FIG. 1 a preferred embodiment of the present invention is shown. The device 10, has an upper section 12 and a lower section 14 separated by score line 16. The upper section 12 contains multiple holes and/or slots 18. The number of the holes and/or slots 18, is not critical and can be manipulated while still being within the scope of this invention. The holes and/or slots 18 must be large enough to receive common telephone wires, computer cables and electrical cords.

FIG. 1 shows a device where the combined height of the upper section 12 and the lower section 14 is three inches and the length of the device 10 is six and three-fourths inches. These measurements are for purposes of illustration only and not mean to limit the scope of the invention in any way.

The device can be made of any solid material including but not limited to plastic, metal, wood, glass, and polymeric film materials. In a preferred embodiment of the present invention the device is made of plastic.

What is claimed is:

1. A device for spacing and organizing telephone, computer, electrical or other wires and cables comprising:
(a) an upper section comprising multiple apertures for receiving said wires and cables; and
(b) a lower section;
wherein the upper section is separated from the lower section by a score line.

2. A device according to claim 1 wherein the multiple apertures comprise a thin slot leading to a hole.

3. A device according to claim 1 made of plastic.

4. A device according to claim 1 made of metal.

5. A device according to claim 1 made of a polymeric material.
